(19) United States
(12) Patent Application Publication
(10) Pub. No.: US 2020/0261928 A1
(43) Pub. Date: Aug. 20, 2020

(54) DISPENSE VALVE WITH DISPOSABLE FLUID BODY

(71) Applicant: NORDSON CORPORATION, WESTLAKE, OH (US)

(72) Inventors: Thomas R. Tudor, Westland, MI (US); William C. Paetow, Pinckney, MI (US); Jerry R. V, Westland, MI (US); David W. Groat, Westland, MI (US)

(21) Appl. No.: 16/758,444

(22) PCT Filed: Oct. 30, 2018
(86) PCT No.: PCT/US2018/058113

§ 371 Date: Apr. 23, 2020

Related U.S. Application Data
(60) Provisional application No. 62/578,867, filed on Oct. 30, 2017.

(51) Int. Cl. B05B 1/30

(52) U.S. Cl. CPC B05B 1/3013

(57) ABSTRACT

A dispense valve assembly for selectively providing fluid to a nozzle from a cartridge of a dispensing apparatus is disclosed. The dispense valve assembly includes a dispense valve including a valve rod and a dispense valve actuator for actuating the valve rod, as well as a component assembly that includes a valve housing and a nozzle adapter. The valve housing defines a proximal end for releasably attaching to the dispense valve, a distal end opposite the proximal end, and an angled extension defining an inlet. The dispense valve assembly also includes a nozzle adapter defining a proximal end for attaching to the distal end of the valve housing and a distal end opposite the proximal end. The dispense valve assembly also includes a nozzle releasably attached to the distal end of the nozzle adapter. The valve housing can be disposed after a single use.

### CROSS REFERENCE TO RELATED APPLICATIONS

This application is a National Stage Application of International Patent App. No. PCT/US2018/058113, filed Oct. 30, 2018, which claims the benefit of U.S. Provisional Patent App. No. 62/578,867, filed Oct. 30, 2017, the entire disclosures of both of which are hereby incorporated by reference as if set forth in their entirety herein.

### TECHNICAL FIELD

The present disclosure relates to a dispensing apparatus including a disposable component assembly that is releasably attached to the dispensing apparatus.

### BACKGROUND

Various types of fluid dispensing apparatuses are used to dispense fluid from a cartridge, through a dispense valve, out a nozzle, and onto a substrate. After the supply of fluid within a particular a cartridge has been depleted, the cartridge must be removed and replaced. Because these materials may be curing, the wetted fluid path and components must be cleaned and rebuilt, or replaced after use. In addition, different cartridges can contain a variety of different types of fluids that may have adverse reactions when exposed to each other, when a cartridge containing a new type of fluid is to be dispensed from the dispensing apparatus, the wetted components of the dispensing apparatus must be removed and flushed or replaced to ensure no amount of the previous fluid remains to avoid contamination.

However, flushing can create many problems for an operator of a dispensing apparatus. Flushing can be time intensive, as components of the dispensing apparatus may require disassembly, solvent flushing, cleaning, and rebuilding before being returned to operation. Further, removing the wetted components of the dispensing apparatus can be time intensive, as a variety of tools may be required. The solvents utilized in flushing the wetted components can cause issues, as many effective solvents cannot be utilized due to their potential for causing fires or other health concerns, which results in less effective solvents being used. As a result, even after using a particular solvent, portions of older fluid may remain within wetted components.

Therefore, there is a need for a wetted component assembly that is easily and quickly detachable from a fluid dispensing apparatus and can reduce the required cleaning time between dispensing operations.

### SUMMARY

An embodiment of the present invention is a component assembly configured to be attached to a dispensing apparatus that includes a cartridge. The component assembly includes a valve housing defining a proximal end configured to be releasably attached to a dispense valve, a distal end opposite the proximal end, and an angled extension defining an inlet. The valve housing defines a valve bore that extends from the proximal end to the distal end for receiving a portion of a valve rod of the dispense valve. The valve housing also defines a discharge passage that extends from the inlet of the angled extension to the valve bore and is in fluid communication with the cartridge. The component assembly also includes a nozzle adapter having a proximal end configured to be attached to the distal end of the valve housing, a distal end opposite the proximal end configured to be releasably attached to a nozzle. The nozzle adapter defines a discharge bore that extends from its proximal end to its distal end and is in fluid communication with the valve bore of the valve housing. The valve housing is configured to be disposed after a single use.

Another embodiment of the present invention is a dispense valve assembly for providing fluid to a nozzle from a cartridge of a dispensing apparatus. The dispense valve assembly includes a dispense valve including a valve rod and a dispense valve actuator for actuating the valve rod, and a valve housing having a proximal end configured to releasably attach to the dispense valve, a distal end opposite the proximal end, and an angled extension defining an inlet. The valve housing defines a valve bore that extends from the proximal end to the distal end for receiving a portion of the valve rod, and a discharge passage that extends from the inlet of the angled extension to the valve bore and is in fluid communication with the cartridge. The dispense valve assembly also includes a nozzle adapter having a proximal end configured to attached to the distal end of the valve housing, a distal end opposite the proximal end, and a discharge bore that extends from the proximal end to the distal end and is in fluid communication with the valve bore of the valve housing. The dispense valve assembly further includes a nozzle configured to be releasably attached to the distal end of the nozzle adapter. The valve housing is configured to be disposed after a single use.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown.

FIG. 1 is a top perspective view of a dispensing apparatus in accordance with the disclosure;

FIG. 2 is a top plan view of the dispensing apparatus shown in FIG. 1;

FIG. 3 is a bottom perspective view of the dispensing apparatus shown in FIG. 1;

FIG. 4 is a bottom perspective view of the dispensing apparatus shown in FIG. 1;

FIG. 5A is a cross-sectional side view of the dispensing apparatus taken along line 5A-5A of FIG. 2;

FIG. 5B is an enlarged view of a portion of the cross-sectional view shown in FIG. 5A;

FIG. 5C is an isometric view of a cartridge mating member in accordance with the disclosure;

FIG. 6 is a rear cross-sectional view of the dispensing apparatus taken along line 6-6 of FIG. 2;

FIG. 7 is a cross-sectional view of a piston rod and piston head of a dispensing apparatus in accordance with the disclosure;

FIG. 8 is a front view of the piston head shown in FIG. 9;

FIG. 9 is a front perspective view of a dispense section in accordance with the disclosure;

FIG. 10A is a cross-sectional view of a portion of the dispense section shown in FIG. 9, with the valve rod in a closed;

FIG. 10B is a cross-sectional view of a portion of the dispense section shown in FIG. 9, with the valve rod in an open position;

FIG. 11 is an exploded view of a portion of the dispense section shown in FIG. 9;

FIG. 12 is a side perspective view of the wetted component assembly of the dispense section shown in FIG. 9;

FIG. 13 is a front perspective view of a dispense section according to another embodiment of the present disclosure;

FIG. 14 is an enlarged side view of a portion of the dispense section shown in FIG. 13;

FIG. 15 is an enlarged cross-sectional view of the dispense section shown in FIG. 13;

FIG. 16A is a perspective view of a nozzle according to a third embodiment of the present disclosure;

FIG. 16B is a perspective view of a nozzle according to a fourth embodiment of the present disclosure;

FIG. 16C is a perspective view of a nozzle according to a fifth embodiment of the present disclosure; and

FIG. 16D is a perspective view of a nozzle according to a sixth embodiment of the present disclosure.

### DETAILED DESCRIPTION OF ILLUSTRATIVE EMBODIMENTS

Described herein is a dispensing apparatus 10 that includes a dispense valve assembly 60, which includes a dispense valve 62 and a wetted component assembly 67 releasably attached thereto. Certain terminology is used to describe the dispensing apparatus 10 in the following description for convenience only and is not limiting. The words “right,” “left,” “lower,” and “upper” designate directions in the drawings to which reference is made. The words “inner” and “outer” refer to directions toward and away from, respectively, the geometric center of the description to describe the dispensing apparatus 10 and related parts thereof. The words “proximal” and “distal” refer to directions and positions on the dispensing apparatus 10 rearward and forward, respectively, of a particular point of reference. The terminology includes the above-listed words, derivatives thereof, and words of similar import.

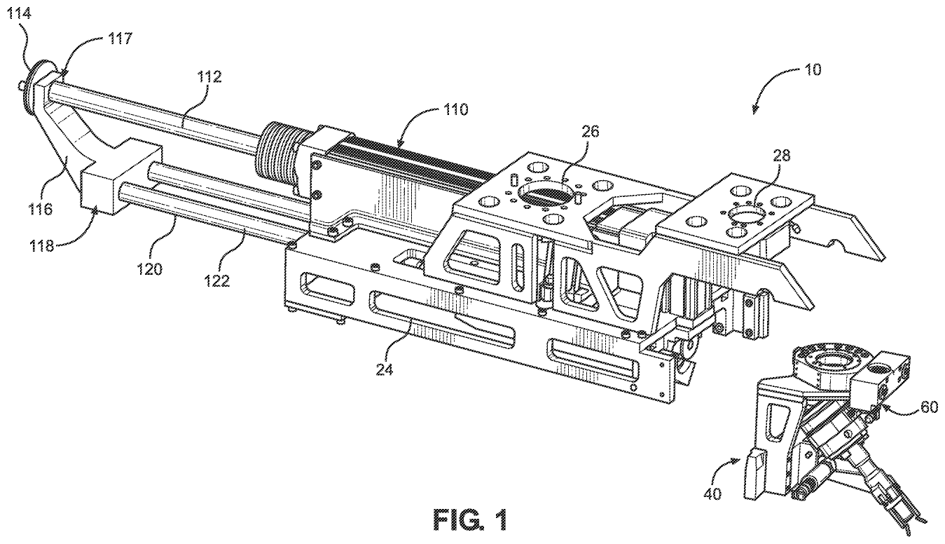

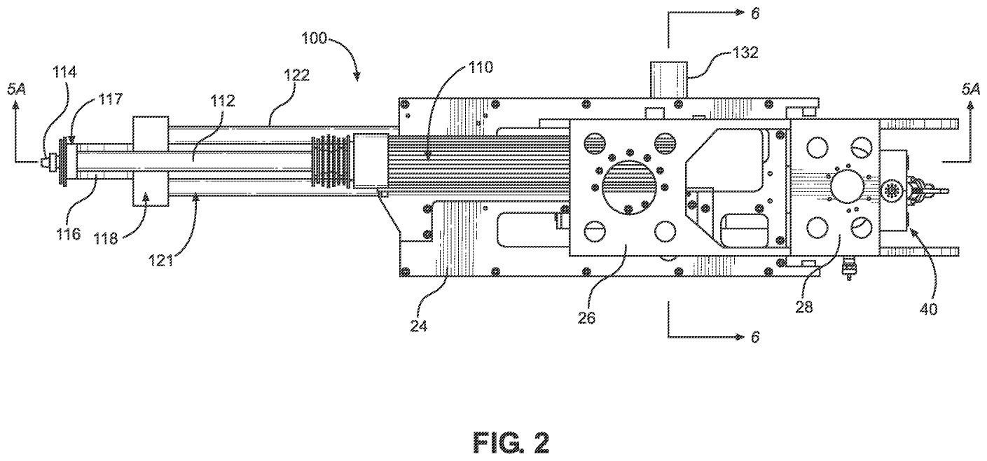

FIGS. 1-6 illustrate a robot-mountable cartridge type dispensing apparatus 10 for dispensing various types of fluids, including but not limited to polysulfides, urethanes, epoxies, adhesives, and silicones, from a cartridge. In the implementation shown, the dispensing apparatus 10 utilizes a fluid cartridge 12 including a cartridge body 14 having a distal end 16 adapted to discharge fluid, a proximal end 18 adapted to receive a piston rod 120, and a fluid space 20 extending between the distal and proximal ends 16, 18. A plunger 22 is positioned in the fluid space 20 and is movable from the proximal end 18 toward the distal end 16 under a force applied by the piston rod 120. The dispensing apparatus 10 also comprises a housing frame 24 having a first robot mounting plate 26 and an end effector assembly 57 having a second mounting plate 28. The first and second robot mounting plates 26, 28 are each configured to removably secure the dispensing apparatus 10 to a robot, such as a robotic arm configured to control movement of the dispensing apparatus 10 to desired locations during the dispensing operation for precise and controlled placement of fluid at an application site.

The dispensing apparatus 10 also comprises a cartridge holder 30 including a first clamshell member 32 and a second clamshell member 34. The cartridge holder 30 is configured to receive the cartridge 12 in a cartridge holding space 36. At least one of the clamshell members 32, 34 is movable toward and away from the other of the clamshell members 32, 34 for allowing the cartridge 12 to be received in and removed from the holding space 36. The dispensing apparatus 10 may be sized to accommodate a variety of cartridge sizes, such as a 6 oz. capacity cartridge or a 12 oz. capacity cartridge.

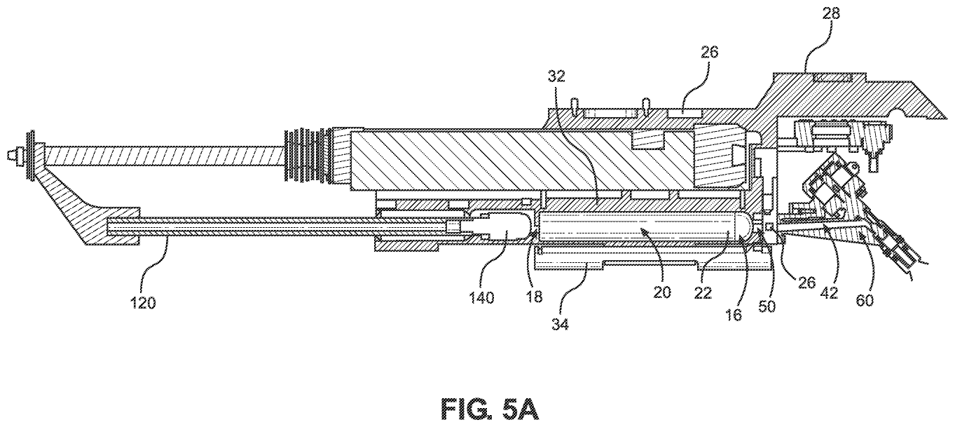

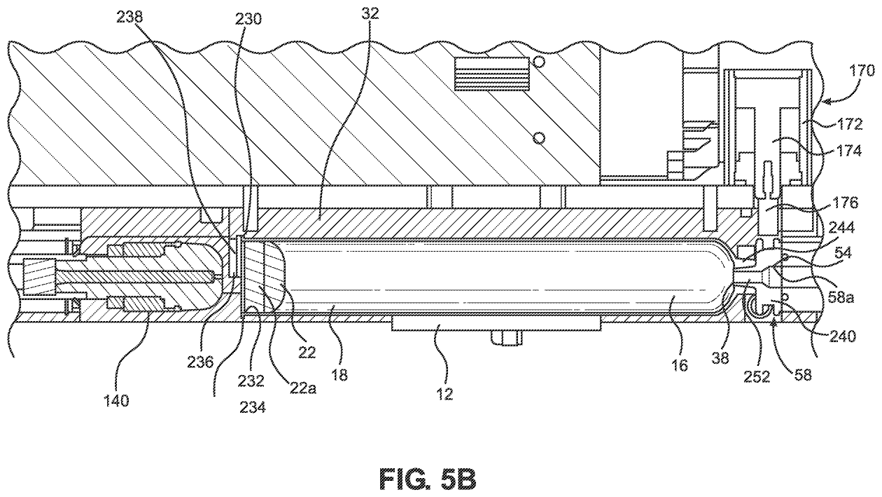

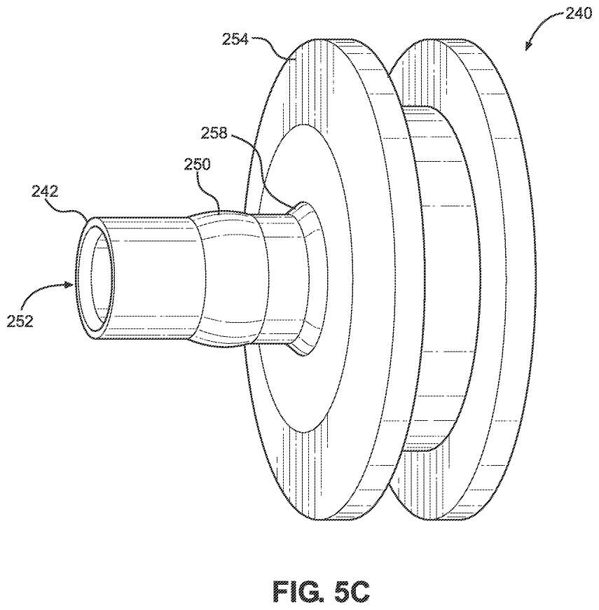

The dispensing apparatus 10 further includes a dispense section 40 having a discharge passage 42 and a discharge outlet 44. The discharge passage 42 communicates with a suitable fluid supply in the cartridge 12. As shown in FIGS. 5A and 5B, the discharge passage 42 receives fluid from a distal outlet passage 38 of the fluid cartridge 12 when the fluid cartridge 12 is received between the first and second clamshell members 32, 34. Thus, the distal outlet passage 38 serves as the supply passage to the dispense section 40. In some implementations a cartridge mating member 240 may be coupled to the distal outlet passage 38, as will later be described in greater detail. A seal 54 is located in surrounding relation to an inlet 56 of the discharge passage 42. This seal 54 may be a face seal that engages a distal tip element 58 of the fluid cartridge 12. Specifically, the seal 54 abuts against an outer surface 58a of the distal tip element 58 that faces in the same direction as the flow of fluid from the cartridge 12. The fluid is further directed to the discharge outlet 44 during a dispensing operation.

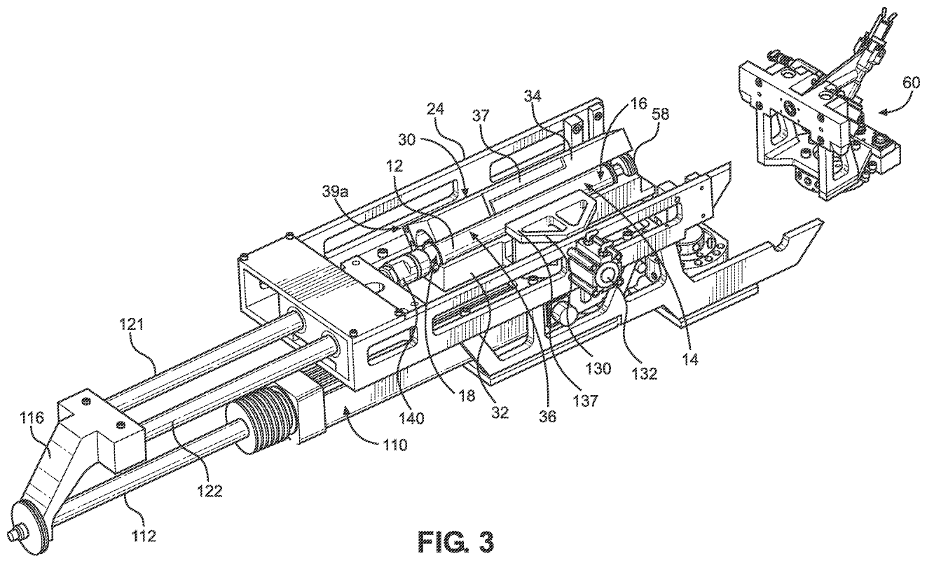

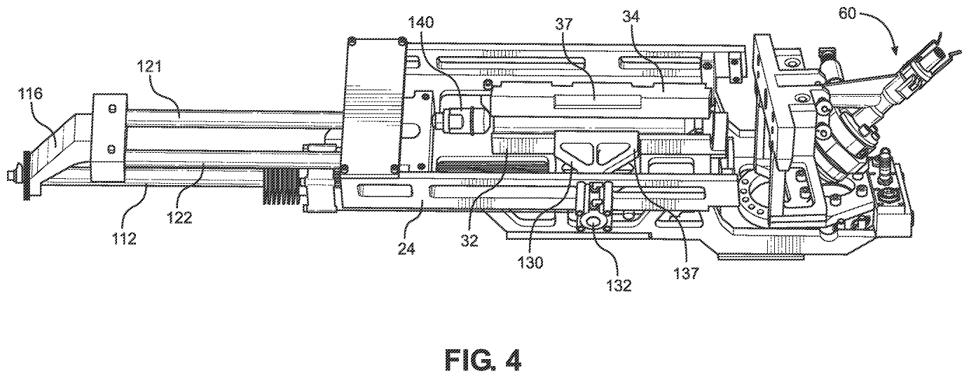

Referring to FIGS. 3-4, the first clamshell member 32 is fixed to the housing frame 24 of the dispensing apparatus 10, and the second clamshell member 34 is pivotally movable relative to the stationary first clamshell member 32. A pair of hinges 39a, 39b provided on a side of the cartridge holder 30 pivotally connect the second clamshell member 34 to the first clamshell member 32, such that the second clamshell member 34 may be pivoted between an open position and a closed position. The open position allows for loading and unloading of the cartridge 12, and the closed position allows for dispensing fluid from the cartridge 12.

The dispensing apparatus 10 further includes a locking member 130 configured to secure the cartridge holder 30 in the closed position by clamping the first and second clamshell members 32, 34 together. The locking member 130 is provided proximate to the side of the cartridge holder 30 opposite the hinges 39a, 39b, and is movably connected to a locking actuator 132. The locking actuator 132 is fixed to a side of the housing frame 24 and is configured to move the locking member 130 in and out of locking engagement with the first and second clamshell members 32, 34. The locking actuator 132 may comprise a pneumatic driver and a reciprocating rod 134 that is coupled to the locking member 130.

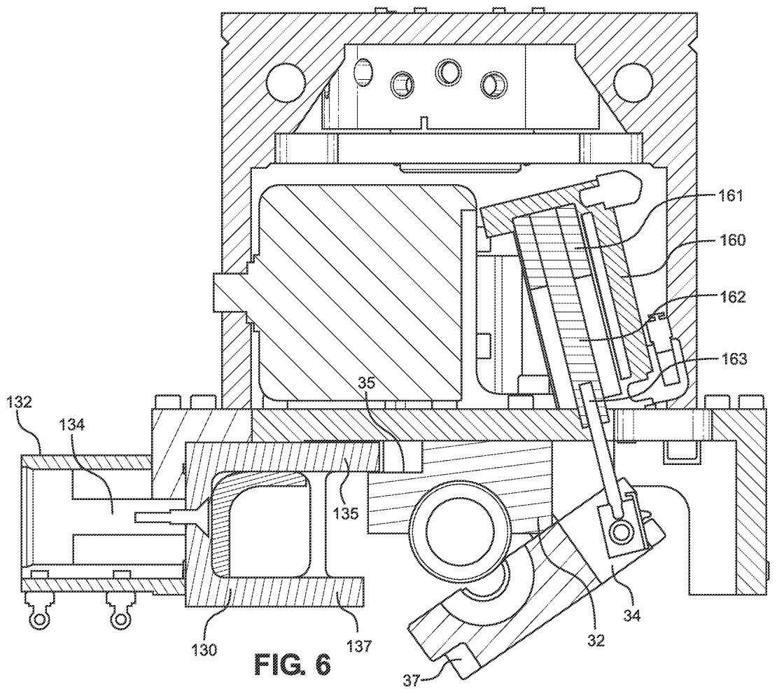

As shown in FIG. 6, the locking member 130 may comprise a first flange member 135 and an oppositely spaced apart second flange member 137 that are configured to mate with a corresponding first shoulder 35 formed on the first clamshell member 32 and a second shoulder 37 formed on the second clamshell member 34, respectively. The movable second clamshell member 34 is actuated between an open position and a closed position by a clamshell actuator 160. The clamshell actuator 160 may comprise a pneumatic cylinder 161 having a reciprocating rod 162 coupled to the pivotable second clamshell member 34 via a connector rod 163. However, other means for moving the second clamshell member 34 between the open and closed positions are contemplated.

Referring again to FIGS. 1-4, a cartridge actuator assembly 100 is configured to dispense fluid from the cartridge 12. The cartridge actuator assembly 100 includes a motor 110, a drive rod 112 coupled to the motor 110, a piston rod 120, and an actuator linkage member 116 configured to couple the drive rod 112 to the piston rod 120. In one implementation, the motor 110 is a servomotor configured to linearly move the drive rod 112 in a reciprocating manner. In other implementations, other types of motors may be used, including a rotary motor or a linear motor. Use of a servomotor has been found to improve reliability of the actuator assembly since it is capable of producing greater thrust than conventional actuator assemblies, while also providing a positive displacement of the fluid material. For instance, the servomotor may generate a force on the plunger that results in pressures up to 400 psi or higher for dispensing highly viscous fluids. In another implementation, movement of the piston rod 120 may be driven by a pneumatic actuator, a hydraulic actuator, or other suitable devices.

A first end 117 of the actuator linkage member 116 is secured to an end of the drive rod 112 by a rod fastener 114, such as a threaded nut. A second end 118 of the actuator linkage member 116 is attached to a first end of the piston rod 120. Accordingly, reciprocating movement of the drive rod 112 caused by the servomotor likewise results in reciprocating movement of the piston rod 120. The piston rod 120 extends from the actuator linkage member 116 in a direction toward the cartridge holding space 36 of the cartridge holder 30, such that the piston rod 120 and the cartridge 12 are coaxially aligned when the cartridge 12 is placed within the cartridge holder 30. Moreover, the piston rod 120 and the drive rod 112 are arranged substantially parallel to each other. At least one auxiliary piston rod 122 may also be connected to the actuator linkage member 116 and configured to move along with the piston rod 120 and the drive rod 112 for providing additional support and stability. Such an auxiliary piston rod 122 is also arranged substantially parallel to the piston rod 120 and the drive rod 112. Both the piston rod 120 and the auxiliary piston rod 122 may be rigidly fixed to the actuator linkage member 116 or removably attached via fasteners such as screws and bolts. The piston rod 120 includes a piston head 140 configured to matingly engage the plunger 22 of the cartridge 12 in order to move the plunger 22 through the fluid cartridge 12 during a dispense operation, as will be described below. In a dispense condition, the plunger 22 of the fluid cartridge is moved from the proximal end 18 to the distal end 16 of the cartridge body 14 by a force applied by the piston rod 120 of the cartridge actuator assembly 100 against the proximal end 22a of the plunger 22. This forces the fluid in the fluid space 20 through the outlet passage 50 of the cartridge 12 and into the discharge passage 42.

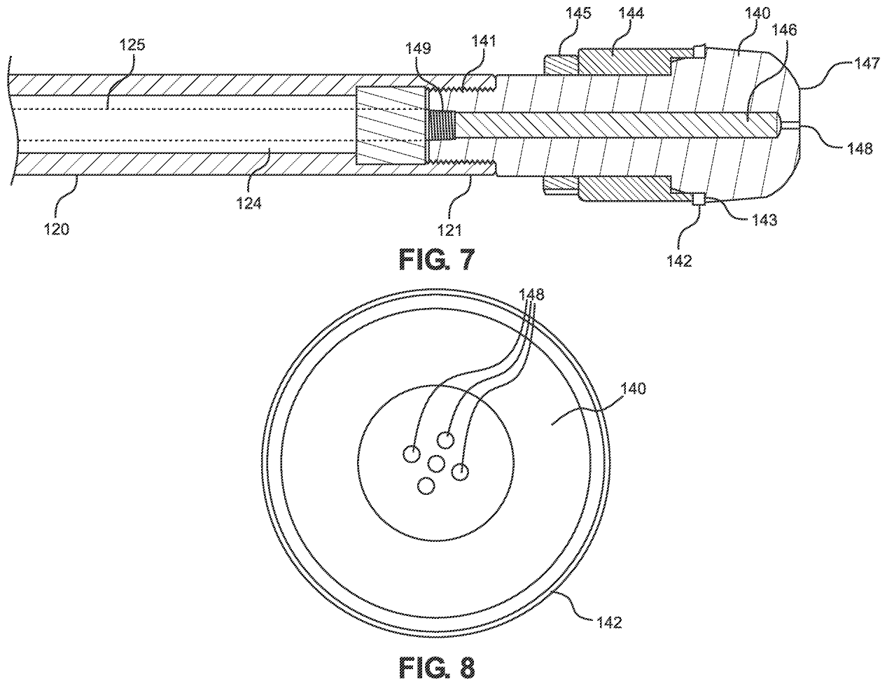

As illustrated in FIG. 7, a piston head 140 is removably attached to the piston rod 120. In one implementation, a proximal end 141 of the piston head 140 is threadedly engaged to a distal end 121 of the piston rod 120. The piston head 140 may be configured to accommodate cartridges 12 of different lengths, different diameters, and different fluid volume capacities. The piston head 140 may further be designed to accommodate for differences that occur due to resulting tolerance variations of the cartridge 12 caused during manufacturing. A resilient piston seal 142 is provided on the piston head 140 between a shoulder 143 of the piston head 140 and an annular seal retainer 144. The seal 142 and seal retainer 144 are secured in place by a fastening member 145, such as a threaded nut. The seal 142 prevents fluid leakage between the piston head 140 and the cartridge 12 during the dispensing operation since the integrity of the seal 142 is maintained even when the tolerances of the outer diameter and the inner diameter of the cartridge 12 vary.

The piston rod 120 defines an internal piston rod passageway 124 that is in fluid communication with an internal piston head passageway 146. A distal end 147 of the piston head 140 includes a vent outlet defining at least one vent hole 148 that is in fluid communication with the piston head passageway 146. The distal end 147 of the piston head 140 is also configured to matingly interface with the proximal end 22a of the plunger 22 of the cartridge 12 in order to maintain the integrity of the plunger 22 during dispensing by preventing it from rolling over or changing shape under pressure. Maintaining the integrity of the plunger 22 further helps prevent fluid leakage between the plunger 22 and the interior walls of the cartridge 12.

In some instances when the piston head 140 enters the cartridge 12 and moves the plunger 22 therethrough to push the fluid out of the cartridge 12, it may be difficult to then move the piston head 140 proximally back out of the cartridge 12. This difficulty may be caused by a vacuum formed between the piston head 140 and the plunger 22 as a result of moving the piston rod 120 distally without having any fluid return to the cartridge 12. The at least one vent hole 148 provides ventilation in order to prevent vacuum pressure when the piston head 140 pushes the plunger 22 during the dispense operation.

In the implementation shown in FIG. 8, for instance, the piston head 140 includes an arrangement of a plurality of vent holes 148, such as five holes, which help to relieve pressure formed when the piston head 140 enters the cartridge 12 and engages the plunger 22. The presence of the at least one vent hole 148 allows for a flow of air into the piston head passageway 146 once the piston head 140 enters the cartridge 12 to urge the plunger 22 during dispensing. Moreover, the presence of multiple vent holes 148 allows for a flow of air even if some of the vent holes 148 become clogged with leaked fluid material. In one implementation, the vent holes 148 may be different sizes. The vent holes 148 may further be arranged in any number of patterns and may be any number of sizes depending on the size of the cartridge 12.

Further, since the inner diameter and outer diameter of each cartridge 12 may change depending on the temperature and other tolerances held during manufacturing, it is necessary to maintain the integrity of the cartridge 12 during the dispensing operation when the pressure inside the cartridge 12 is increased, in order to avoid breaking the cartridge and having fluid material flow uncontained throughout the dispensing apparatus 10. Furthermore, the cartridge 12 is captured and retained in position so that it can be pressurized. Accordingly, when the piston head 140 matingly interfaces with the plunger 22, the air trapped therebetween flows through the at least one vent hole 148 and into the piston head passageway 146 for relieving pressure between the piston head 140 and the plunger 22. As previously described, the piston head 140 may be threadedly attached to the piston rod 120 so that it can easily be removed and cleaned or replaced in the event of fluid leakage.

In one implementation, the cartridge 12 may contain a two-part curing material, such as a polysulfide two-component premixed and frozen material. The distal end of the piston head 140 may be configured to attach to an internal safety hose 125, such as a vinyl hose, extending through the piston rod passageway 124 of the piston rod 120. The proximal end 141 of the piston head 140 includes internal threads 149 for threadedly engaging a push fitting to connect to the internal safety hose 125. The internal safety hose 125 can be connected to a pneumatic directional valve and pressure regulator (not shown), such that during retraction of the piston head 140 from the cartridge 12, positive air pressure can be applied to the area between the piston head 140 and the plunger 22 to relieve vacuum pressure and prevent the plunger 22 from deforming. Also, in the event that leaked fluid material enters into the piston head passageway 146 through the vent holes 148, the leaked fluid can be blown out before it cures. Moreover, the internal safety hose 125 prevents leaked fluid material from adhering to, gumming up, or otherwise clogging the piston rod passageway 124 of the piston rod 120. In one implementation, the internal safety hose 125 extends through the piston rod 120 and terminates in a pig tail end so that an operator can connect to the pig tail end and blow out material from the internal safety hose 125. Without the internal safety hose 125, any leaked fluid material that enters the piston head passageway 146 and/or the piston rod passageway 124 could harden and block airflow, thus rendering the components unusable for venting air.

Once the plunger 22 is urged to the distal end 16 of the cartridge 12 by the piston head 140 at the end of the dispense cycle, the piston head 140 can be removed from the cartridge 12 by operating the servomotor in the reverse direction to retract the piston rod 120. The dispensed cartridge 12 may then be removed from the cartridge holder 30, and a new cartridge may be placed in the dispensing apparatus 10. Turning again to FIG. 5B, the dispenser may include a cartridge ejector 170 configured to eject the fluid cartridge 12 at the end of the dispense cycle and/or when the fluid cartridge 12 is empty and in need of replacement. The cartridge ejector 170 may be used to eject the cartridge 12 from the holding space 36 after the first and second clamshell members 32, 34 of the cartridge holder 30 have been unclamped by actuating the locking member 130 to the unlocked position as previously described above. The cartridge ejector 170 comprises a pneumatic actuator 172 defining a cylindrical ejector housing and a pneumatic ejector piston 174 mounted for reciprocation within the ejector housing. The ejector piston 174 is coupled to an ejector element 176 that is configured to engage and lift at least the distal tip element 58 and the distal end 16 of the cartridge 12. Once ejected, the cartridge 12 may be grasped either manually or in an automated manner, such as by a robotic grasping mechanism. Alternatively, the dispensing apparatus 10 can be positioned over a waste receptacle to receive the ejected cartridge 12. In another implementation, the cartridge ejector 170 may comprise a lever configured to eject a cartridge 12.

One implementation of the cartridge 12 may include a flange 230 defining a flange stop surface 232 configured to retain the cartridge 12 within the dispensing apparatus 10. When the cartridge 12 is placed within the cartridge holder 30, the flange stop surface 232 abuts against a distal stop surface 234 defined by the first clamshell member 32 to limit the travel of the cartridge 12 in a distal direction. The flange 230 is located in a flange groove 238 defined by the first and second clamshell members 32, 34. A proximal stop surface 236 defined by the first clamshell member 32 will engage the flange 230 to limit the axial travel of the cartridge in the proximal direction. As such, the flange groove 238 is defined in part by the distal stop surface 234 and the proximal stop surface 236.

Continuing with FIGS. 5B-5C, the cartridge 12 connects with a cartridge mating member 240, which has a projection 242. A projection receiver 244 located in the distal end 16 of the cartridge 12 fits over the projection 242 to attach the cartridge 12 to the cartridge mating member 240 in a sealed manner. The projection receiver 244 on the cartridge 12 can slip over the projection 242 when the cartridge 12 is pushed onto the cartridge mating member 240. The projection receiver 244 flexes to fit over the projection 242. The flexure of the projection receiver 244 may be limited by a retaining ring. A space between the retaining ring and the projection receiver 244 indicates the amount the projection receiver 244 can flex before it is stopped by the retaining ring. The projection 242 is used to connect the cartridge 12 to the dispensing apparatus 10 and provide fluid communication between the cartridge 12 and the discharge passage 42 in a sealed manner.

The cartridge mating member 240 has a retaining band 250 on the projection 242. The supply passage is defined by an interior passageway 252 of the cartridge mating member 240 that provides fluid communication between the cartridge 12 and the discharge passage 42 through the projection 242 and the body 254 of the cartridge mating member 240. A fillet 258 may be provided between the projection 242 and the body 254. It will be appreciated that moving the projection receiver 244 over the projection 242 may cause some flexure of the projection receiver 244, and moving the projection receiver 244 over the retaining band 250 will cause the greatest flexure of the projection receiver 244. The retaining band 250 may have a smooth surface to facilitate flexure and movement of the projection receiver 244 over the retaining band 250. In some implementations, the retaining band 250 may have a relief area that has a slightly larger interior diameter than the interior diameter of the rest of the projection receiver 244. The retaining band relief area may cause the projection receiver 244 to flex back toward its non-flexed or less-flexed position when the retaining band 250 is aligned with the retaining band relief area. This creates a bias toward the projection receiver 244 to maintain the retaining band relief area aligned with the retaining band 250.

In further implementations of the disclosure, operation of the dispensing apparatus 10 may be controlled by a controller or a plurality of controllers connected to various elements of the dispensing apparatus 10. Various types of controllers may be used, including local controllers and/or remote controllers. Further, the controllers may have wired or wireless connections.

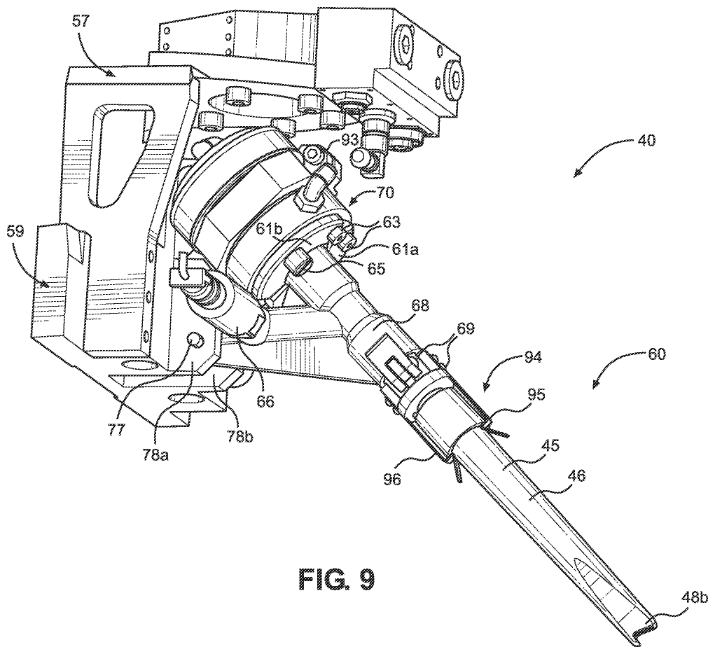

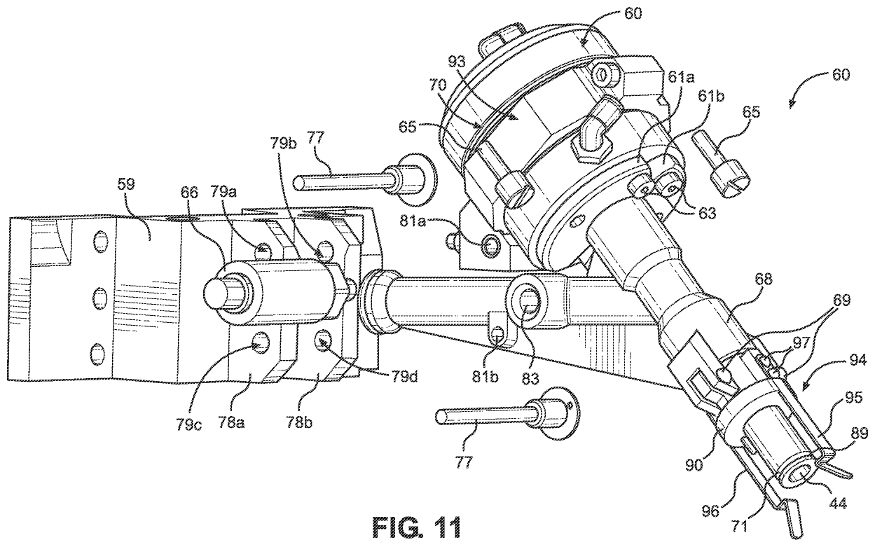

As stated previously, fluid is forced from the fluid space 20 through the outlet passage 50 of the cartridge 12 and into the discharge passage 42 of the dispense section 40. Referring to FIGS. 9-12, the dispense section 40 includes a dispense valve assembly 60 and an end effector assembly 57 configured to releasably attach the dispense valve assembly 60 to the housing frame 24, as will be discussed further below. The dispense valve assembly 60 can include a dispense valve actuator 70 for moving a dispense valve 62 between an open position, in which fluid may flow from the cartridge 12, through the discharge passage 42, and to the discharge outlet 44, and a closed position, in which no fluid may flow from the cartridge 12, through the discharge passage 42, and to the discharge outlet 44. This movement facilitates controlling whether fluid is dispensed from the cartridge 12 and out of the dispensing apparatus 10. Additionally, the dispense valve assembly 60 includes a valve rod 64, as will be described further below. The dispense valve 62, the dispense valve actuator 70, and the valve rod 64 may be made of any suitable material, including steel, hardened steel, or any other suitable substance, such as plastic for minimizing cured material adhesion.

The dispense valve 62 may be operated in a reciprocating manner between the open and closed positions by operating the dispense valve actuator 70. The dispense valve actuator 70 can comprise a pneumatic piston valve 72 housed within a valve actuator housing 74, specifically within a cylindrical bore 75 defined by the valve actuator housing 74. A proximal end 64a of the valve rod 64 is connected to the pneumatic piston valve 72. The pneumatic piston valve 72 divides the cylindrical bore 75 into two chambers: a first chamber 76a on a proximal side of the pneumatic piston valve 72, and a second chamber 76b on a distal side of the pneumatic piston valve 72. The bore 75 is configured to receive pressurized air into the first chamber 76a, which imparts a force on the pneumatic piston valve 72 in the distal direction. As a result of this force, both the pneumatic piston valve 72 and the valve rod 64 translate in the distal direction, which moves the dispense valve 62 to the open position. The bore 75 is also configured to receive pressurized air into the second chamber 76b, which imparts a force on the pneumatic piston valve 72 in the proximal direction. As a result of this force, both the pneumatic piston valve 72 and the valve rod 64 translate in the proximal direction, which moves the dispense valve 62 to the closed position, as will be discussed further below. Though the dispense valve 62 is described as a pneumatic valve, in other embodiments the dispense valve can be a rotary ball valve, a ball and seat valve, a pinch valve, or other types of on/off control valves.

Continuing with FIGS. 9-12, the dispense valve assembly 60 can further include a valve housing 68 coupled to the dispense valve 62 and a first embodiment of a nozzle adapter 90 coupled to the valve housing 68. The valve housing 68 and the nozzle adapter 90 can collectively comprise the wetted component assembly 67, as will be described further below. The valve housing 68 defines a proximal end 68a, a distal end 68b opposite the proximal end 68a, and an angled extension 68c that extends away from the proximal and distal ends 68a, 68b in the proximal and lateral directions and defines an inlet 56. The valve housing 68 has a valve bore 82 that extends from the proximal end 68a to the distal end 68b, and is configured to receive at least a portion of the valve rod 64. The valve housing 68 also includes the discharge passage 42, which extends from the inlet 56 located on the angled extension 68c to the valve bore 82, and provides fluid from the cartridge 12 to the valve bore 82.

As stated, the valve rod 64 is partially received in the valve bore 82 of the valve housing 68. The valve rod 64 defines a proximal end 64a attached to the pneumatic piston valve 72, and a distal end 64b opposite the proximal end 64a. The valve rod 64 also defines a first wide region 85a located at the proximal end 64a, a second wide region 85b located at the distal end 64b, and a narrow region 86 that extends from the first wide region 85a to the second wide region 85b. The first and second wide regions 85a, 85b each define a diameter that is larger than the diameter of the narrow region 86. Though the depicted as being similar, the diameters of the first and second wide regions 85a, 85b can differ. In one embodiment, the diameters of the first and second wide regions 85a, 85b of the valve rod 64 are about 0.50 inches. In contrast, the diameter of the narrow region 86 of the valve rod 64 can be about 0.188 inches.

The second wide region 85b of the valve rod 64 is received within a discharge bore 80 of the nozzle adapter 90. The discharge bore 80 extends from a proximal end 90a of the nozzle adapter 90 to the discharge outlet 44 at the distal end 90b of the nozzle adapter 90. The discharge bore 80 may also be tapered, such that the portion of the discharge bore 80 that receives the second wide region 85b defines a larger diameter than a portion of the discharge bore 80 near the discharge outlet 44. However, the diameter of the discharge bore 80 may also remain constant along the length of the nozzle adapter 90. The proximal end 90a of the nozzle adaptor 90 can be attached to the distal end 68b of the valve housing 68 through a variety of means, such as a press fit, threaded engagement, or tongue and groove system, such that the nozzle adaptor 90 and the valve housing 68 are releasably coupled. Alternatively, the nozzle adapter 90 and the valve housing 68 can be permanently coupled, such as through adhesive. The dispense valve assembly 60 can also include an O-ring 92 disposed around the proximal end 90a of the nozzle adapter 90 that creates a fluid seal between the valve housing 68 and the nozzle adapter 90. The O-ring 92 can prevent fluid from exiting the discharge bore 80 and/or the valve bore 82 to an area exterior to the dispensing apparatus 10. Likewise, the nozzle adaptor 90 can include a groove 89 defined by the distal end 90b that is configured to receive a seal 71. The seal 71 can maintain a fluid seal between the nozzle adapter 90 and a nozzle 45 attached to the distal end 90b of the nozzle adapter 90, as fluid is transferred to the nozzle 45 from the dispense valve assembly 60 through the discharge outlet 44. Though one specific nozzle is shown, it is contemplated that the dispensing apparatus 10 can include a variety of types of nozzles. Also, the nozzle adapter 90 and the nozzle 45 is designed such that the nozzle 45 can be attached and removed manually or utilizing automation.

With continued reference to FIG. 9-12, the dispense valve assembly 60 can also include a first valve rod seal 84a and a second valve rod seal 84b disposed within the wetted component assembly 67. The first valve rod seal 84a can be positioned within the valve housing 68, particularly the valve bore 82, proximal to where the discharge passage 42 connects with the valve bore 82. The first valve rod seal 84a is positioned around the first wide region 85a to prevent fluid from passing from the valve bore 82 to any part of the dispense valve 62. As the valve rod 64 translates along the proximal and distal directions, the first valve rod seal 84a maintains a fluid seal around the valve rod 64 to prevent leaking of the fluid. Conversely, the second valve rod seal 84b is positioned within the valve housing 68, particularly the valve bore 82, at a location distal to where the discharge passage 42 connects with the valve bore 82. The second valve rod seal 84b can be contacted on a proximal end by a portion of the valve housing 68 and a distal end by a portion of the nozzle adapter 90, such that the second valve rod seal 84b is maintained in position during operation of the dispensing apparatus 10. In one embodiment, both the first and second valve rod seals 84a and 84b can be quad ring seals. However, other types of seals are contemplated, such as O-rings, lip seals, etc.

In operation, the interaction between the valve rod 64 and the second valve rod seal 84b prevents fluid from flowing through the discharge passage 42 and to the discharge outlet 44 when the dispense valve 62 is in the closed position, and allows fluid to flow through the discharge passage 42 and to the discharge outlet 44 when the dispense valve 62 is in the open position. When the dispense valve 62 is in the closed position, the second wide region 85b of the valve rod 64 is positioned proximally within the discharge bore 80, such that the upper end of the second wide region 85b engages the second valve rod seal 84b. The engagement between the second wide region 85b and the second valve rod seal 84b creates a fluid seal that prevents fluid from flowing from the valve bore 82 to the discharge bore 80. As a result, an operator of the dispensing apparatus 10 can control the flow of fluid from the dispense valve assembly 60 to the nozzle 45, or can prevent leaking of fluid out of the dispense valve assembly 60 during a shut-down period of the dispensing apparatus 10. An operator can also pre-pressurize the fluid by advancing the piston head 140 into the cartridge 12 when the dispense valve 62 is in the closed position until the fluid reaches a desired pressure. Pre-pressurizing the fluid allows for greater control of the shape of the beginning of a dispensed bead or form. When the dispense valve 62 is in the open position, the second wide region 85b of the valve rod is positioned distally within the discharge bore 80, such that a gap exists between the second wide region 85b and the second valve rod seal 84b. As a result, the narrow region 86 of the valve rod 64 is aligned with the second valve rod seal 84b. Due to the decreased diameter of the narrow region 86 in comparison to the second wide region 85b, fluid can flow between the valve rod 64 and the second valve rod seal 84b when the dispense valve 62 is in the open position. As previously stated, in a dispense condition the plunger 22 of the fluid cartridge 12 is moved from the proximal end 18 to the distal end 16 of the cartridge body 14 by a force applied by the piston rod 120 of the cartridge actuator assembly 100 against the proximal end 22a of the plunger 22. When the dispense valve 62 is also in the open position, this force forces the fluid in the fluid space 20 through the outlet passage 50 of the cartridge 12, into the discharge passage 42, through the discharge bores 80, 82, and through the discharge outlet 44. In contrast, when the dispense valve 62 is in the closed position, this force cannot force the fluid through the discharge bores 80, 82 and through the discharge outlet 44 due to the engagement between the second wide region 85b of the valve rod 64 and the second valve rod seal 84b.

To provide feedback on the pressure of fluid flowing through the components of the dispense valve assembly 60, the dispense valve assembly 60 can include a pressure transducer 66. In particular, the pressure transducer 66 can be in fluid communication with the discharge passage 42 through a transducer bore 83 that extends from an exterior surface of the angled extension 68c of the valve housing 68 to the discharge passage 42. During operation of the dispensing apparatus 10, the pressure transducer 66 can provide feedback to an operator through an electrical connection to a controller. Based upon the feedback provided by the pressure transducer 66, the operator can adjust the operation of the dispensing apparatus 10 as desired. The pressure transducer 66 can be releasably coupled to the valve housing through a threaded connection defined by the transducer bore, such that the pressure transducer can be manually separated from the valve housing 68. However, other means of attachment are contemplated, such as pins, friction fitting, snap engagement, etc.

Various parts of the dispense section 40 of the dispensing apparatus 10 can be removably coupled to each other to allow for easy disassembly. Referring to FIG. 9, the end effector assembly 57 can include an attachment portion 59 that is configured to secure the end effector assembly 57 to the dispense valve assembly 60. The attachment portion 59 can define a first tab 78a and a second tab 78b that is laterally spaced from the first tab 78a, such that a gap exists between the first and second tabs 78a, 78b. Each of the first and second tabs 78a, 78b can define at least one bore that extends therethrough for receiving a fastener. In the depicted embodiment, the first tab 78a defines a first bore 79a and a third bore 79c, and the second tab defines a second bore 79b and a fourth bore 79d. The first and second bores 79a, 79b substantially align, while the third and fourth bores 79c, 79d substantially align. Likewise, a clamp 93 attached to the valve actuator housing 74 defines a first bore 81a, while the valve housing 68 defines a second bore 81b. Though the first bore 81a is depicted as being defined by a clamp 93, the first bore 81a can be defined by any other portion of the dispense valve assembly 60, such as the valve housing 68 or the valve actuator housing 74. To attach the dispense valve assembly 60 to the end effector assembly 57, the first bore 81a of the clamp 93 and the second bore 81b of the valve housing 68 are placed between the first and second tabs 78a, 78b, such that the first bore 79a of the first tab 78a, the first bore 81a of the clamp 93, and the second bore 79b of the second tab 78b align, and the third bore 79c of the first tab 78a, the second bore 81b of the valve housing 68, and the fourth bore 79d of the second tab 78b align. Then, an operator of the dispensing apparatus 10 inserts two pins 77 through the bores. The pins 77 may each be detent pins, such that an operator can manually insert the pins 77 through the bores and remove the pins 77 from the bores without the use of tools. However, other types of pins are contemplated.

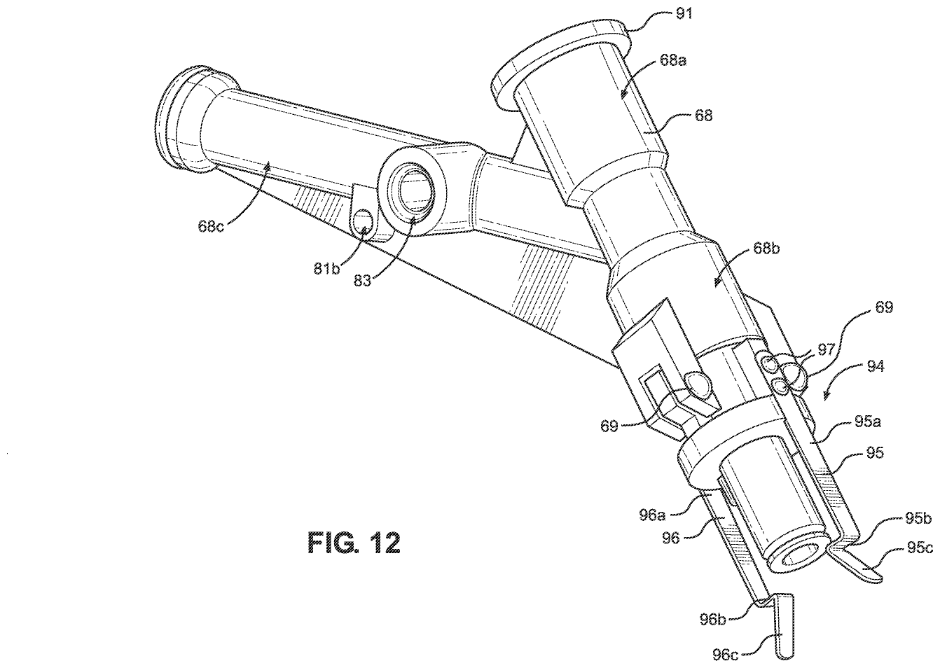

The valve housing 68 is also releasably coupled to the valve actuator housing 74. The dispense valve assembly 60 can include first and second retainers 61a, 61b coupled to the valve actuator housing 74 via respective pivot pins 63. When unlocked, the first and second retainers 61a, 61b can each rotate freely about an axis. However, a thumb screw 65 can be inserted through bores that extend through each of the first and second retainers 61a, 61b and into the valve actuator housing 74, such that the first and second retainers 61a, 61b are rotationally fixed relative to the valve actuator housing 74. The first and second retainers 61a, 61b can both be configured to engage a flange 91 (shown in FIG. 12) defined at the proximal end 68a of the valve housing 68. To engage the flange 91, an operator of the dispensing apparatus 10 rotates the first and second retainers 61a, 61b to a first position away from each other and presses the proximal end 68a of the valve housing 68 against the valve actuator housing 74. Then, the operator rotates the first and second retainers 61a, 61b towards each other to a second position, such that the first and second retainers 61a, 61b engage the flange 91. To lock the first and second retainers 61a, 61b in place in the first position, the operator inserts the thumb screws 65 through the bores defined by the first and second retainers 61a, 61b and into the valve actuator housing 74, twisting the thumb screws 65 to impart a desired force on the first and second retainers 61a, 61b. As a result, the steps of attaching and detaching the valve housing 68 and the valve actuator housing 74 can be performed by an operator of the dispensing apparatus 10 without the use of any tools.

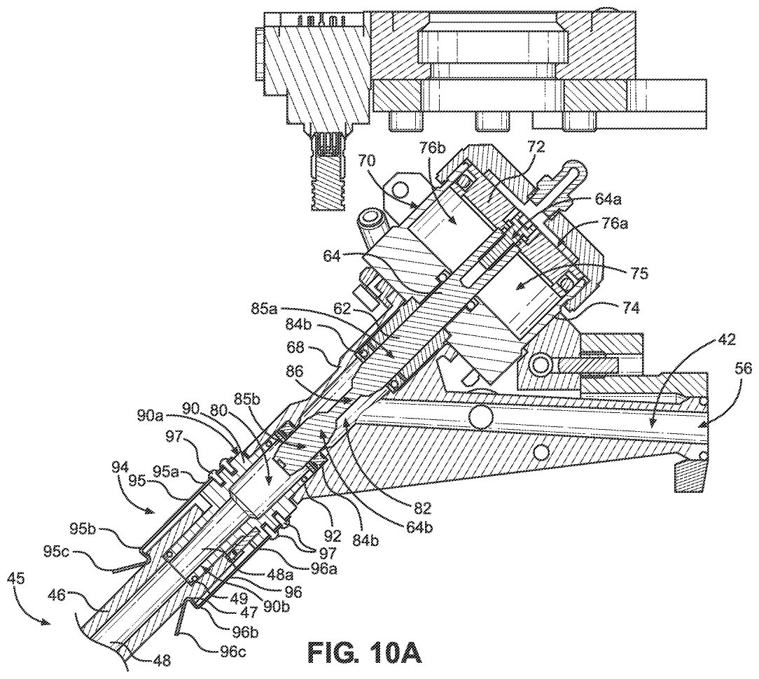

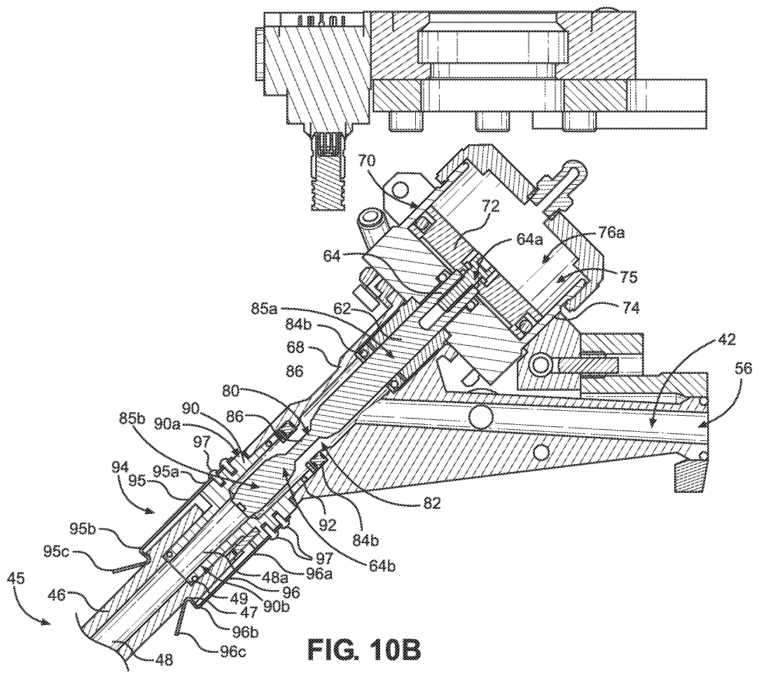

Now referring to FIGS. 10A-12, the wetted component assembly 67 can be comprised primarily of the valve housing 68 and the nozzle adapter 90. However, the wetted component assembly 67 can also include such features as the seal 71, O-ring 92, first valve rod seal 84a, and second valve rod seal 84b. During assembly of the dispense valve assembly 60, the wetted component assembly 67 can be provided preassembled. As shown, pins 69 engage both the nozzle adapter 90 and the valve housing 68 to secure the nozzle adapter 90 to the valve housing 68. The pins 69 may permanently attach the nozzle adapter 90 to the valve housing 68, or may allow for the nozzle adapter 90 and the valve housing 68 to be decoupled. However, in other embodiments the pins 69 may not be used, and the valve housing 68 and nozzle adapter 90 can be secured to each other through adhesives.

The dispense section 40 can further include a nozzle 45 for dispensing the material. The nozzle 45 can include a body 46 that defines a passage 48 extending therethrough from an inlet 48a to an outlet 48b, where the inlet 48a is configured to receive the material from the nozzle adapter 90, as well as receive a portion of the nozzle adapter 90 during assembly, and the outlet 48b is configured to dispense the material. The body 46 can define an outer ledge 47 for receiving a portion of the device that secures the nozzle 45 to the nozzle adapter 90, as will be discussed below, as well as an inner ledge 49 defined within the passage 48, where the inner ledge 49 is configured to limit the extent to which a portion of the nozzle adapter 90 extends through the inlet 48a.

The nozzle adapter 90 can be releasably coupled to the nozzle 45 used to dispense the fluid provided by the cartridge 12. In one embodiment, the dispense valve assembly 60 can include a retainer 94 configured to engage the nozzle 45. The retainer 94 includes first and second clips 95, 96, where the first and second clips 95, 96 are disposed on vertically opposite sides of the nozzle adapter 90. Each of the first and second clips 95, 96 can be comprised of a thin piece of metal, so as to be easily bendable by a user. In the depicted embodiment, each of the first and second clips 95, 96 can be attached to the nozzle adapter 90 using a plurality of fasteners 97. The fasteners 97 can be bolts, screws, or any other type of conventionally used fastener. Further, the fasteners 97 may releasably or permanently couple the first and second clips 95, 96 to the nozzle adapter 90. Though fasteners 97 are specifically shown as being utilized for attaching the first and second clips 95, 96 to the nozzle adapter 90, other methods of attachment may be used, such as welding, adhesive bonding, etc. The first clip 95 may extend from an upper section 95a, which defines the region where the fasteners 97 attach the first clip 95 to the nozzle adapter 90, to an inwardly-extending second section 95b, to an outwardly-extending third section 95c. Similarly, the second clip 96 may extend from an upper section 96a, which defines the region where the fasteners 97 attach the second clip 96 to the nozzle adapter 90, to an inwardly-extending second section 96b opposite the second section 95b, to an outwardly-extending third section 96c opposite the third section 95c.

In operation, to attach the nozzle 45 to the nozzle adapter 90, the operator slides the distal end 90b of the nozzle adapter 90 through the inlet 48a of the nozzle 45, until the distal end 90b engages the inner ledge 49. As this is occurring, the first and second clips 95, 96 will bend outwards over the body 46 of the nozzle 45 until the second sections 45b, 46b engage the outer ledge 47. At this point, first and second clips 95, 96 will bend inwards, and the engagement between the outer ledge 47 and the second sections 45b, 46b will lock the nozzle 45 to the nozzle adapter 90. As a result, the nozzle 45 is capable of being attached to the nozzle adapter 90 manually by the operator without the use of any tools. To release the nozzle 45 from the nozzle adapter 90, the operator grasps the third sections 95c, 96c of the first and second clips 95, 96 and bends them outwards, releasing the second sections 95b, 96b from engagement with the outer ledge 47 of the nozzle 45. The operator can then easily slide the distal end 90b of the nozzle adapter 90 out of the nozzle 45, and replace the nozzle 45 or parts of the wetted component assembly 67.

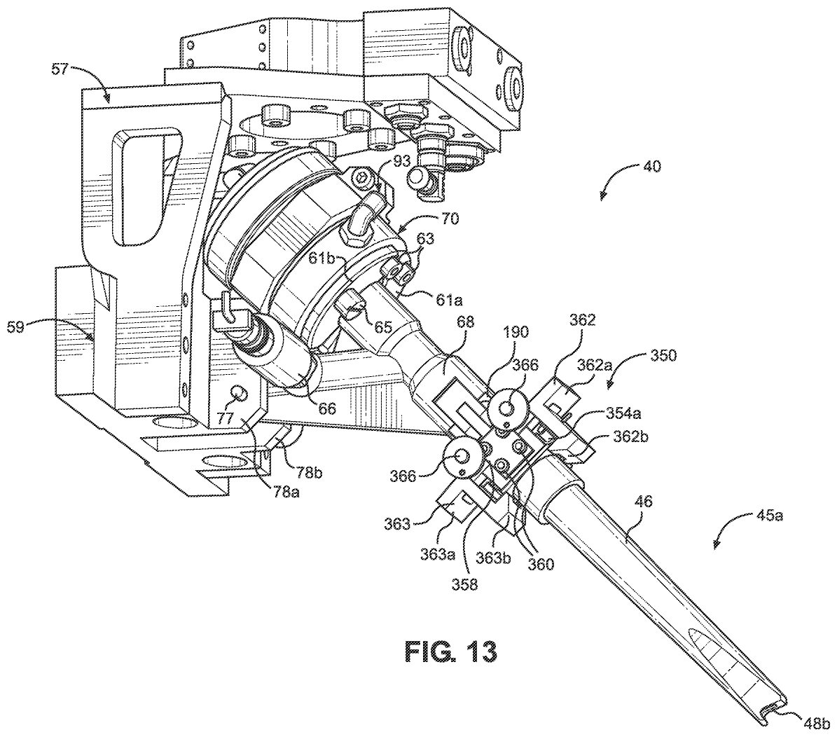

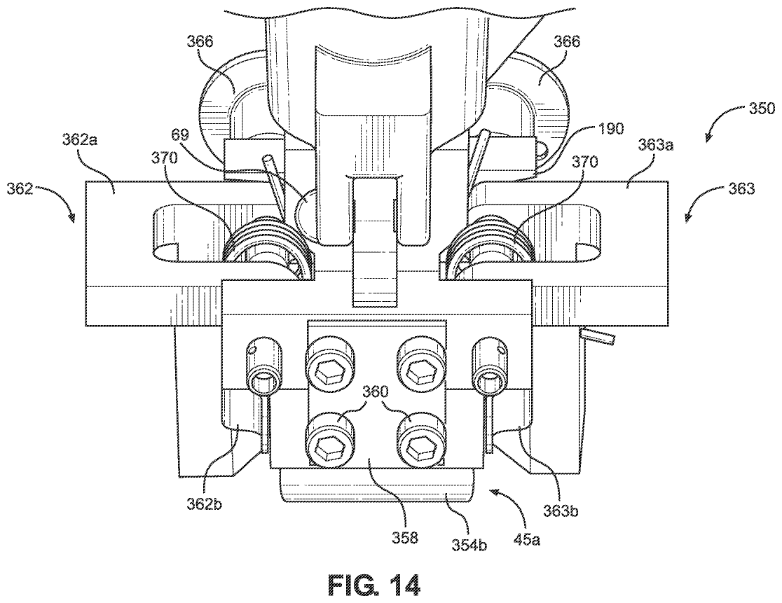

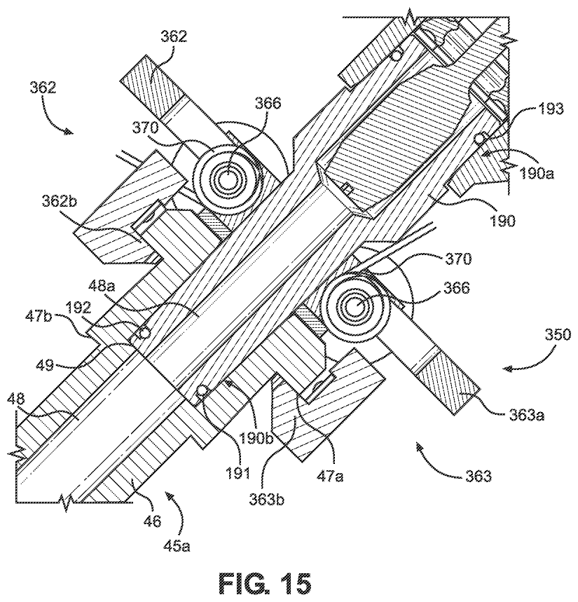

Referring to FIG. 13-15, further embodiments of a nozzle 45a, nozzle adapter 190, and retainer 350 will be described. Like the nozzle adapter 90, the nozzle adapter 190 can have a proximal end 190a configured to be attached to the distal end 68b of the valve housing 68 to a distal end 190b configured to be received by the nozzle 45a. An O-ring 193 can be disposed around the proximal end 190a of the nozzle adapter 90 that creates a fluid seal between the valve housing 68 and the nozzle adapter 190. The distal end 190b can define a groove 191 for receiving a seal 192, which can be an O-ring, for creating a fluid seal between the nozzle adapter 190 and the nozzle 45a. The nozzle 45a is similar to the nozzle 45, in that the nozzle 45 has a body 46 that defines a passage 48 extending therethrough from an inlet 48a to an outlet 48b, where the inlet 48a is configured to receive the material from the nozzle adapter 190, as well as receive a portion of the nozzle adapter 190 during assembly, and the outlet 48b is configured to dispense the material. The body 46 can define a distal outer ledge 47a and a proximal outer ledge 47b, where the proximal outer ledge 47b is configured to receive a portion of the device that secures the nozzle 45a to the nozzle adapter 190, as will be discussed below. The nozzle 45a also includes an inner ledge 49 defined within the passage 48, where the inner ledge 49 is configured to limit the extent to which a portion of the nozzle adapter 190 extends through the inlet 48a.

The nozzle adapter 190 can be releasably coupled to the nozzle 45a used to dispense the fluid provided by the cartridge 12. The dispense valve assembly 60 can include a retainer 350 configured to engage the nozzle 45. The retainer 350 can include first and second body plates 354a, 354b disposed on laterally opposite sides of the nozzle 45a. Each of the first and second body plates 354a, 354b are configured to attach to the nozzle adapter 190 through respective plates 358, where a plurality of fasteners 360 secure the plates 358 to the nozzle adapter 190, as well as secure the plates 358 to the respective first and second body plates 354a, 354b. The fasteners 360 can be bolts, screws, or any other type of conventionally used fastener. Further, the fasteners 360 may releasably or permanently couple the plates 358 to the nozzle adapter 190 and the first and second body plates 354a, 354b. Although fasteners 360 are shown as being used to attach the plates 358 to the nozzle adapter 190 and the first and second body plates 354a, 354b, other methods of releasably or permanently attaching these features may be utilized, such as welding, adhesives, slot and groove attachment, etc.

The retainer 350 can also include a first arm 362 and a second arm 363 vertically opposite the first arm 362. The first arm 362 can be rotatably attached to the nozzle adapter 190 via a rod 366 that extends through a portion of the first arm 362 and a portion of the nozzle adapter 190. Similarly, the second arm 363 can be rotatably attached to the nozzle adapter 190 via a rod 366 that extends through a portion of the second arm 363 and a portion of the nozzle adapter 190. The first arm 362 can define a first extension 362a that extends laterally outwards from the first arm 362 and a second extension 362b positioned vertically below the first extension 362a and extend laterally inwards from the first arm 362. Similarly, the second arm 363 can define a first extension 363a that extends laterally outwards from the first arm 363 and a second extension 363b positioned vertically below the first extension 363a and extend laterally inwards from the first arm 363. Respective springs 370 are disposed around each of the rods 366 so as to rotationally bias the first and second arms 362, 363 into a closed position, as will be discussed below.

In operation, the first and second arms 362, 363 can be rotated between open and closed positions, where in the open position, the second extensions 362b, 363b of the first and second arms 362, 363 are rotated outwards, while in the closed position, the second extensions 362b, 363b are rotated inwards. To attach the nozzle 45a to the nozzle adapter 190, the operator rotates the first and second arms 362, 363 about the rods 366 into the open position by rotating the first extensions 362a, 363a inwards, thus rotating the second extension 362a, 362b radially outwards so as to provide clearance for receiving the nozzle 45a. Then, the distal end 190b of the nozzle adapter 190 is inserted into the inlet 48a of the nozzle 45a until the distal end 190b contacts the inner ledge 49. After this, the first extensions 362a, 363a can be released, and the springs will bias the first and second arms 362, 363 into the closed position. In the closed position, the second extensions 362b, 363b will engage the proximal outer ledge 47b, thus preventing the nozzle 45a from backing out of engagement with the nozzle adapter 190. The retainer 350 can be freely rotated between open and closed position by the operator. As a result, the nozzle 45a is capable of being attached to the nozzle adapter 90 manually by the operator without the use of any tools.

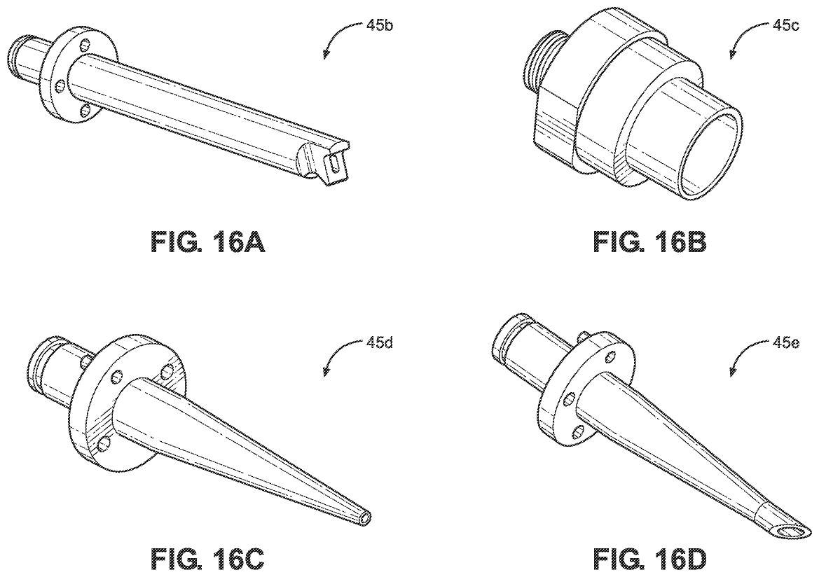

Now referring to FIGS. 16A-16D, additional nozzle embodiments are depicted, where each of the nozzle embodiments can be configured for a specific purpose. FIG. 16A shows a nozzle 45b that can be used to create a fillet of sealant onto the joint of two overlapping surfaces. FIG. 16B shows a nozzle 45c that can be used to apply sealant over the top of fasteners that protrude from a flat surface. FIGS. 16C and 16D show nozzles 45d, 45e that can be used to apply fillets of sealant to two surfaces creating a 90 degree angle. Though several nozzle embodiments are described, the present disclosure is not intended to be limited as such.

As noted above, in previous embodiments of dispensing apparatuses, removal of the wetted components could be time and labor intensive. However, various features of the dispense valve assembly 60 of the present application help alleviate this problem. For instance, the interaction of the flange 91 of the valve housing 68, the first and second retainers 61a, 61b, and the thumb screws 65 allow the valve housing 68 and valve actuator housing 74 to be easily coupled and decoupled by hand without the aid of tools. Additionally, the interaction between the pins 77, the first and second tabs 78a, 78b, the clamp 93, and the valve housing 68 can allow the valve housing 68 and the end effector assembly 57 to be easily coupled and decoupled by hand without the aid of tools. Further, the interaction between the retainers 94, 350, the nozzle adapter 90, and the nozzle 45, 45a allow the nozzle 45, 45a and nozzle adapter 90 to be easily coupled and decoupled by hand without the aid of tools. The aforementioned features allow an operator of the dispensing apparatus 10 to quickly manually detach the wetted component assembly 67 from the rest of the dispensing apparatus 10, significantly cutting down the time and labor output related to switching dispensing operations or shutting down a dispensing operation at the end of a shift.

The ability of the wetted component assembly 67 to be provided as a complete assembly and comprised of materials such as reinforced nylon, acrylonitrile butadiene styrene (ABS) plastic (or other types of plastic), nitrile rubber, and/or acetal allows the wetted component assembly 67, or either component of the wetted assembly 67 (the valve housing 68 and the nozzle adapter 90, 190), to be a one-use item that is disposable after a single use. This completely removes the requirement to flush the wetted components with solvent, providing significant time and cost savings when switching or shutting down dispensing operations. With the wetted component assembly 67, once the wetted component assembly 67 is removed from the dispensing apparatus 10, either or both of the valve housing 68 and the nozzle adapter 90, 190 can simply be discarded and a new wetted component assembly used. The inclusion of the transducer bore 83 allows the more expensive pressure transducer 66 to be removed from the wetted component assembly 67 before it is discarded.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The claims are therefore not limited to the specific details, representative apparatus and methods and illustrative examples shown and described.

What is claimed is:

1. A component assembly configured to be releasably attached to a dispensing apparatus that includes a cartridge, the component assembly comprising:
a valve housing having a proximal end configured to be releasably attached to a dispense valve, a distal end opposite the proximal end, and an angled extension defining an inlet, wherein the valve housing defines a valve bore that extends from the proximal end to the distal end for receiving a portion of a valve rod of the dispense valve, and defines a discharge passage that extends from the inlet of the angled extension to the valve bore and is in fluid communication with the cartridge; and
a nozzle adapter having a proximal end configured to be attached to the distal end of the valve housing, a distal end opposite the proximal end configured to be releasably attached to a nozzle, wherein the nozzle adapter defines a discharge bore that extends from its proximal end to its distal end and is in fluid communication with the valve bore of the valve housing,
wherein the valve housing is configured to be disposed after a single use.

2. The component assembly of claim 1, wherein the valve housing is comprised of a polymer.

3. The component assembly of claim 2, wherein the polymer is reinforced nylon.

4. The component assembly of claim 1, wherein the angled extension defines a transducer bore in fluid communication with the discharge passage, wherein the transducer bore is configured to releasably receive a pressure transducer.

5. The component assembly of claim 1, further comprising:
a first valve rod seal disposed within the valve bore; and
a second valve rod seal disposed within the valve bore distally from the first valve rod seal.

6. The component assembly of claim 5, wherein the first valve rod seal is configured to contact a first wide region of the valve rod and the second valve rod seal is configured to selectively contact a second wide region of the valve rod that is separated from the first wide region by a narrow region.

7. The component assembly of claim 1, wherein the distal end of the nozzle adapter defines a groove for receiving a seal, wherein the seal is configured to provide a fluid seal between the nozzle adapter and the nozzle.

8. The component assembly of claim 1, wherein the proximal end of the valve housing comprises a flange for engaging at least one retainer attached to the dispense valve.

9. The component assembly of claim 1, wherein the proximal end of the nozzle adapter is configured to be releasably attached to the distal end of the valve housing.

10. A dispense valve assembly for providing fluid to a nozzle from a cartridge of a dispensing apparatus, the dispense valve assembly comprising:
a dispense valve including a valve rod and a dispense valve actuator for actuating the valve rod;
a valve housing defining a proximal end configured to be releasably attached to the dispense valve, a distal end opposite the proximal end, and an angled extension defining an inlet, wherein the valve housing defines a valve bore that extends from the proximal end to the distal end for receiving a portion of the valve rod, and defines a discharge passage that extends from the inlet of the angled extension to the valve bore and is in fluid communication with the cartridge;
a nozzle adapter having a proximal end configured to be attached to the distal end of the valve housing, a distal end opposite the proximal end, wherein the nozzle adapter defines a discharge bore that extends from its proximal end to its distal end and is in fluid communication with the valve bore of the valve housing; and
a nozzle configured to be releasably attached to the distal end of the nozzle adapter,
wherein the valve housing is configured to be disposed after a single use.

11. The dispense valve assembly of claim 10, wherein the valve housing is comprised of a polymer.

12. The dispense valve assembly of claim 11, wherein the polymer is reinforced nylon.

13. The dispense valve assembly of claim 10, further comprising:
a pressure transducer configured to be releasably received in a transducer bore defined by the angled extension of the valve housing, wherein the transducer bore is in fluid communication with the discharge passage.

14. The dispense valve assembly of claim 10, further comprising:
a first valve rod seal disposed within the valve bore; and
a second valve rod seal disposed within the valve bore distally from the first valve rod seal.

15. The dispense valve assembly of claim 14, wherein the valve rod has a first wide region configured to contact the first valve rod seal, a second wide region configured to selectively contact the second valve rod seal, and a narrow region that extends form the first wide region to the second wide region.

16. The dispense valve assembly of claim 10, further comprising:
a seal received in a groove defined by the distal end of the nozzle adapter, wherein the seal provides a fluid seal between the nozzle adapter and the nozzle.

17. The dispense valve assembly of claim 10, wherein the proximal end of the valve housing comprises a flange, the dispense valve further comprising:
at least one retainer attached to the dispense valve, wherein the retainer is rotatable between a first position, where the retainer is disengaged from the flange such that the valve housing is separated from the dispense valve, and a second position, where the retainer engages the flange such that the valve housing is coupled to the dispense valve.

18. The dispense valve assembly of claim 17, further comprising:
at least one thumb screw for engaging the at least one retainer and the valve housing, wherein the at least one retainer is locked in the first position when the at least one thumb screw engages the at least one retainer and the valve housing.

19. The dispense valve assembly of claim 10, wherein the proximal end of the nozzle adapter is configured to be releasably attached to the distal end of the valve housing.

20. The dispense valve assembly of claim 19, further comprising:
at least one pin for coupling the proximal end of the nozzle adapter to the distal end of the valve housing.

21. The dispense valve assembly of claim 10, wherein the dispense valve defines a first bore and the valve housing defines a second bore, wherein the first bore extends through a portion of the dispense valve and the second bore extends through the valve housing, the dispense valve assembly further comprising:
an end effector assembly for attaching the dispense valve assembly to the dispensing apparatus, the end effector assembly comprising:
a first tab having a first bore and a second bore extending therethrough, wherein the first bore is spaced from the second bore; and
a second tab having a first bore and a second bore extending therethrough, wherein the first bore is spaced from the second bore,
wherein the first bore of the first tab and the first bore of the second tab align with the first bore of the valve housing when the end effector assembly is attached to the valve housing, and the second bore of the first tab and the second bore of the second tab align with the second bore of the valve housing when the end effector assembly is attached to the valve housing.

22. The dispense valve assembly of claim 21, further comprising:
a first detent pin for coupling the valve housing to the end effector assembly, wherein the first detent pin extends through the first bore of the first tab, the first bore of the valve housing, and the first bore of the second tab; and
a second detent pin for coupling the valve housing to the end effector assembly, wherein the second detent pin extends through the second bore of the first tab, the second bore of the valve housing, and the second bore of the second tab.
